(19) United States
(12) Patent Application Publication
(10) Pub. No.: US 2006/0163143 A1
(43) Pub. Date: Jul. 27, 2006

(54) Microliter scale solid phase extraction devices

(76) Inventors: Gabriela S. Chirica, Livermore, CA (US); Ronald F. Renzi, Tracy, CA (US); Blake A. Simmons, San Francisco, CA (US)

Correspondence Address: Mark W. Roberts, Ph.D., Esq.;DORSEY & WHITNEY LLP, Suite 3400, 1420 Fifth Avenue, Seattle, WA, 98101, US

(21) Appl. No.: 11/044,788

(22) Filed: Jan. 26, 2005

(51) Int. Cl. B01D 63/00

(52) U.S. Cl. 210/321.84; 73/863.23; 422/101; 210/321.6; 422/100

(57) ABSTRACT

Microliter scale solid phase extraction devices for preparing analytes in microliter volumes are disclosed. A re-useable device is provided in cartridge form that includes a central containment member with a containment bore that holds as little as 1 to 5 μl or less of a solid phase material that binds the analyte. The containment bore is enclosed on either side by a porous membrane that has an inner portion exposed for fluid flow and a peripheral portion that is sealed against fluid flow. The seal is formed by engaging the periphery of the porous membranes between sealing surfaces of the central containment member and corresponding sealing surfaces on first and second conduit assemblies that comprise the remainder of the cartridge. A non-reuseable device is provided in “chip” form, which includes a porous filter sandwiched between top and bottom wafers each having a plurality corresponding input and output conduits for a plurality of samples.

### STATEMENT REGARDING RESEARCH & DEVELOPMENT

This invention was made with Government support under government contract no. DE-AC04-94AL85000 awarded by the U.S. Department of Energy to Sandia Corporation. The Government has certain rights in the invention, including a paid-up license and the right, in limited circumstances, to require the owner of any patent issuing in this invention to license others on reasonable terms.

### TECHNICAL FIELD

This invention relates to solid phase extraction devices for extraction, concentration, separation and purification of analytes in microliter scale samples.

### BACKGROUND OF THE INVENTION

Analytical instrumentation for biological and chemical analytes has increasingly become more sensitive and is now capable of detecting extraordinarily small amounts of sample materials that may be contained in microliter or submicroliter scale volumes. For example, micro HPLC systems are available for chromatographic separation of samples over columns as little as 75 μm×5 cm in dimension. Similarly, capillary electrophoresis (CE) systems are capable of separating analytes in a sample as small as 2 nl.

Unfortunately, HPLC and CE systems are sophisticated and expensive instruments that require considerable sample processing (e.g., clean-up, fractionation and concentration) prior to actual analysis. There is an ongoing need in the art for inexpensive and easy to use devices for preparing the type of microliter scale samples suitable for analysis on such sophisticated instruments. One conventional solution to this problem has been to pack microliter pipette tips or small columns with 10-200 μl of solid phase chromatography media. Retaining the chromatography media in the tips or columns in a stable position presents a problem. One solution is to employ a porous glass or organic polymer retainer, known as a “frit,” at the top and bottom of the chromatography media. Use of a frit, however, often introduces problems of non-specific binding of analytes as well as incomplete recovery and dilution of the sample. Most importantly, these frits are fragile and can readily be broken or extruded.

Yet another solution, known as “particle entrapment” is to immobilize the chromatography media in a matrix of an inert polymer. A major problem with this solution is that the packed chromatography media can often escape the trapping matrix, making such devices unreliable for routine use. Loose packing is particularly undesirable if the next step involves on-chip analysis or use of detectors, such as mass spectrometers, that can be damaged by these particles. Yet another problem with all the above solutions is that it is difficult to control the rate and volume of fluid flow through the chromatography media to sub-microliter tolerances of about 1 μl or less.

There remains, therefore, a need in the art for inexpensive, easy to use and reliable devices for microliter scale manipulation of chemical and biological samples that is rapid, can be operated at low pressures, is adaptable for use with existing absorbent material and analytical instrumentation, and for which the fluid control properties can be controlled at sub-microliter tolerances.

### SUMMARY OF THE INVENTION

Provided herein are microliter scale solid phases extraction (μSPE) devices for microliter scale treatment of fluid samples. In one embodiment, the device is provided in a cartridge form that includes a central containment member having a containment bore disposed therethrough with openings at input and output ends of the containment bore. A volume defined by the containment bore between the input and output ends is less than 500 μl and more typically 1 to 10 μl or less. Each of the input and output ends of the first containment bore are surrounded by first and second sealing surfaces adjacent to the input and output ends, respectively. The cartridge further includes first and second conduit assemblies having a first and second conduit bores disposed therethrough with first and second openings, respectively, surrounded by a third and fourth sealing surfaces adjacent to the respective openings. A first porous membrane is sealingly engaged between the first sealing surface of the first containment bore and the third sealing surface of the first conduit assembly so that a perimeter of the first porous membrane is sealed from fluid flow while a first fluid contact area of the first porous membrane is disposed between the input opening of the containment bore and the first opening of the first conduit. A second porous membrane is sealingly engaged between the second sealing surface of the containment bore and the fourth sealing surface of the second conduit assembly so that a perimeter of the second porous membrane is sealed from fluid flow while a second fluid contact area of the second porous membrane is disposed between the output opening of the containment bore and the second opening of the second conduit. A solid phase material is placed in the volume of the containment bore between the first and second porous membranes so that the solid phase material is enclosed at the input and output ends of the containment bore between the first and second fluid contact areas of the first and second porous membranes. When thus configured, microliter scale samples can be absorbed and eluted from the solid phase material in the cartridge with little or no dilution to facilitate concentration, separation and purification of analytes in microliter volumes. The cartridge form of the μSPE device is re-useable and can be filled with a variety of different solid phase materials.

Also provided is a chip embodiment of a μSPE device. The chip embodiment includes an input conduit bore having a first longitudinal axis longitudinally disposed in a first wafer with the first longitudinal axis being transverse to a first plane of the first wafer. The input conduit bore has an input end and an output end. The device further includes an output conduit bore having a second longitudinal axis longitudinally disposed in a second wafer with the second longitudinal axis being transverse to a second plane of the second wafer. The output conduit bore also has an input end and an output end. At least one third wafer is sandwiched between the first and second wafers. The third wafer includes a containment bore into which a solid phase material is packed. The solid phase material is enclosed in the containment bore on opposing ends by first and second porous members, each being surrounded at the periphery by a sealing surface. The first, second and third wafers are bonded together so the first and second longitudinal axes of the respective input and output bores are positioned so that a sample flows from the input bore in the first wafer, through the second porous membrane in the third wafer and out through the output bore of the second wafer. A first peripheral seal surrounds the output end of the input bore and a second peripheral seal surrounds the input end of output bore, each sealing surface being configured to engage the corresponding sealing surface on the periphery of the containment bore so that fluid flows from the input bore through the first membrane, into the containment bore, and out of the second porous membrane only at a central fluid contact area of the membrane. In certain embodiments, multiple third wafers having different solid phase materials packed in different containment bores are stacked between the first and second wafers so that a sample flows through multiple solid phase materials contained in separate wafers in one application and these embodiments include a third porous membrane positioned between the first sample bore of the third wafer and the separate sample bore in the separate wafer. In typical embodiments, the wafers are provided with a plurality of input and output conduits and a plurality of containment bores so that a plurality of samples can be processed using one chip.

### BRIEF DESCRIPTION OF THE DRAWINGS

FIG. 1 is an exploded cutaway view of a cartridge embodiment of a μSPE device provided herein.

FIG. 2 is an isometric view of a detail of a central containment member with a containment bore and a porous membrane used in the μSPE devices provided herein.

FIG. 3 illustrates one embodiment of sealing surfaces having corresponding shapes that may be used in certain embodiments of the μSPE devices provided herein.

FIGS. 4A-4E illustrates example embodiments of external conduits that may be used in the μSPE devices provided herein.

FIG. 5 illustrates a μSPE cartridge fully assembled, and including the conduit fittings and solid phase material packed in the containment bore.

FIG. 6 illustrates steps in the assembly of the μSPE cartridge 10 and loading of the solid phase material into the first containment bore.

FIGS. 6A and 6B illustrate an embodiment with multiple central containment members coupled in a line to form the first containment bore.

FIG. 7 illustrates a heat transfer element incorporated with a μSPE cartridge device.

FIG. 8 illustrates a μSPE cartridge that includes lateral conduit fitting assemblies.

FIG. 9 illustrate volume adapters for the containment bore of a μSPE cartridge.

FIG. 10 is accuracy side view of wafer chip embodiment of a μSPE device provided herein, FIG. 10 b is an isometric view.

FIG. 11A depicts one embodiment of a stacked wafer chip μSPE device.

FIG. 11B depicts an embodiment of a stacked wafer chip μSPE device having separate containment bores in different wafers interconnected via a microfluidic channel. FIG. 11C depicts an embodiment of a stacked wafer chip μSPE device with a valve like piston element in the microfluidic channel. FIG. 11D depicts an embodiment wafer chip μSPE device configured with electrodes to lyse cells, organelles or viruses contained in the device.

FIG. 12 depicts an example embodiment of a system configured with μSPE cartridges for lysing and analyzing cells.

FIG. 13 is a chromatogram illustrating loading, concentrating and eluting a BSA using a μSPE cartridge.

FIG. 14A illustrates concentration of BSA using an anion exchange material in a μSPE cartridge. FIG. 14B illustrates concentration of lactalbumin and lysozyme in a μSPE cartridge packed with a hydrophobic solid phase material.

FIG. 15 illustrates reproducible recovery with repeated use of the same μSPE cartridge.

FIG. 16 illustrates cartridge-to-cartridge reproducibility with different μSPE cartridges.

### DETAILED DESCRIPTION OF PREFERRED EMBODIMENTS

Provided herein are microliter scale Solid Phase Extraction (μSPE) devices for manipulating and treating microliter sample volumes for analytical or preparative purposes. The μSPE devices fulfill a need in the analytical arts for inexpensive, easy to use, and reliable devices for reproducible and rapid preparation and analysis of very small sample sizes (e.g., sample sizes that are in the range of 0.1 to 500 μl and typically between about 1.0 to 10 μl). The μSPE devices are useful in a wide variety of applications, including but not limited to, concentrating, separating and purifying analytes in microliter scale volumes according to chemical or physical properties and for integration with sample analysis systems where many samples can be rapidly prepared and analyzed.

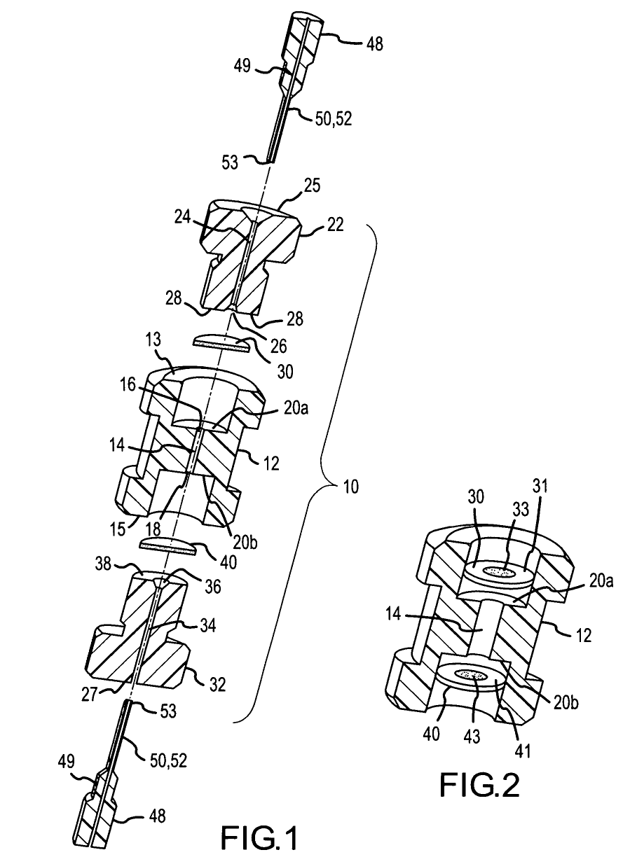

FIG. 1 shows one example of a μSPE device embodied in cartridge form. The μSPE cartridge 10 includes three basic elements. The first element is a central containment member 12 that has a first containment bore 14 formed through a portion thereof with openings 16, 18 on opposing ends. For purposes of distinction, the components of the μSPE devices may be described with reference to opposing components as being either an “input” or “output” component to reflect a sequential flow of a sample through the various components of the devices. It will be appreciated, however, that the μSPE devices are typically made in a symmetrical configuration as exemplified in the present drawings and that sample fluids can flow in either direction. Therefore, the terms “input” and “output” are understood to be relative terms that are reversible in situations where the direction of the fluid flow is reversed. Accordingly the end openings 16, 18 at the ends of the first containment bore 14 are herein denoted as an “input end” 16 and an “output end” 18, respectively, to reflect a flow of fluid through the first containment bore 14 as entering the input end 16 and exiting the output end 18.

Adjacent to the input end 16 of the first containment bore 14 is a first sealing surface 20a that surrounds the opening at the input end 16. A second sealing surface 20b is likewise adjacent to, and surrounds, the opening at the output end 18 of the first containment bore 14. A first porous membrane 30 is positioned over the input end 16 and a second porous membrane 40 is positioned over the output end 18 of the first containment bore 14. The first and second porous membranes 30, 40 thereby enclose a volume defined by the cross sectional area of the first containment bore 14 multiplied by its length between the first and second porous membranes 30, 40. In various embodiments, the enclosed volume is 500 μl or less or 200 μl or less, and in most advantageous embodiments, the enclosed volume is 100 μl or less, 50 μl or less, 20 μl or less, 10 μl or less, 5 μl or less, or 1 μl or less.

As depicted in the isometric view of FIG. 2, when the first porous membrane 30 is placed over the input end 16 of the first containment bore 14 a central portion of the first porous membrane 30 defines a first fluid contact area 33 through which fluid can pass into the first containment bore 14. A perimeter portion 31 of the first porous membrane 30 is positioned over the first sealing surface 20a of the central containment member 12. Likewise, when the second porous membrane 40 is placed over the output end 18 of the first containment bore 14, a central portion of the second porous membrane 40 defines a second fluid contact area 43 through which fluid can pass outward from the first containment bore 14. A perimeter area 41 of the second porous membrane 40 is similarly positioned over the second sealing surface 20b of the central containment member 12 to prevent fluid flow through the periphery of the second porous membrane 40.

Returning to FIG. 1, the central containment member 12 is configured at a first distal end 13 to removably engage a first conduit assembly 22 above the input end 16 of the first containment bore 14. In typical embodiments, the containment member 12 is also configured at the opposite (second) distal end 15 to removably engage a second conduit assembly 32 below the output end 18 of the first containment bore 14. The first conduit assembly 22 includes a first conduit bore 24 formed there through that has an output opening 26 that faces the first porous membrane 30 when the input conduit assembly 22 is engaged with the central containment member 12. The output opening 26 for the first conduit bore 24 may have the same width as the first conduit bore 24, or as in the embodiment depicted, the output opening 26 may flare outwardly to have a wider dimension at its end than the width of the first conduit bore 24. The wider dimension of the output opening for the first conduit bore 26 spreads fluid flowing outwardly from the first conduit bore 24 over an area that matches the area of the first fluid contact area 33 on the first porous membrane 30.

The first conduit assembly 22 further includes a third sealing surface 28 adjacent and peripheral to the output opening 26 of the first conduit bore 34 to surround the output opening 26. The third sealing surface 28 on the first conduit assembly 22 is configured to conform with the dimensions of the first sealing surface 20a of the central containment member 12. When the first conduit assembly 22 is tightened to fully engage the central containment member 12, the first sealing surface 20a of the central containment member 12 and the third sealing surface 28 of the input conduit assembly 22 are compressed together around the first porous membrane 30 to form a fluid flow resistant seal around the periphery 31 of the first porous membrane 30 while leaving the first fluid contact area 33 free to receive a flow a fluid from the output opening 26 of the first conduit bore 24 into the first containment bore 14.

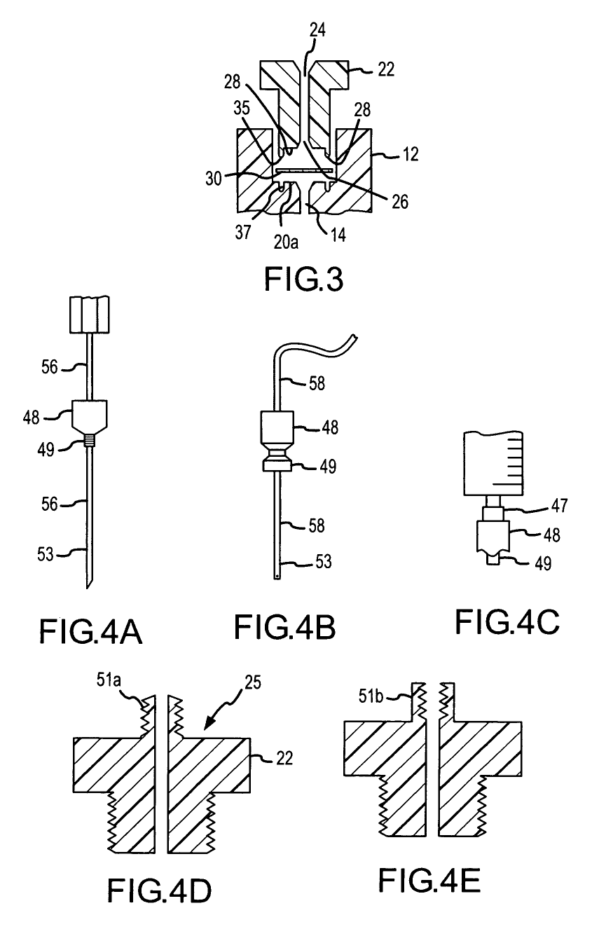

In certain optional embodiments, a compressible ring, for example, a rubber, nylon, or Teflon “O” ring may be positioned between the first sealing surface 20a and the third sealing surface 28 on either side of the first porous membrane 30 to facilitate formation of a flow resistant seal. However, such embodiments are not typically desirable because the use of an “O” ring adds a finite volume of space to the sample input and output vestibules that will tend to dilute the sample. In more typical embodiments such as depicted, a flow resistant seal is formed when both the first sealing surface 20a and the third sealing surface 28 are flat surfaces planed to a sufficient tolerance to allow uniform pressure to be exerted around the periphery 31 of the first porous membrane 30. In yet other embodiments, as depicted in FIG. 3, the first sealing surface 20a and the third sealing surface 28 can be formed of correspondingly fitting shapes, for example, where one sealing surface is an annular convex ridge 35 and the other sealing surface is an annular concave channel 37, so that the convex ridge 35 fits into the concave channel 37 and depresses the first porous membrane 30 between the corresponding surfaces to block fluid flow at the periphery.

Returning to FIG. 1, the second conduit assembly 32 is a mirror image of the first conduit assembly 22. The second conduit assembly 32 includes a second conduit bore 34 formed there through with an input opening 36 that faces the second porous membrane 40 when the second conduit assembly 32 is engaged with the central containment member 12. The input opening 36 for the output conduit bore 36 may have the same width as the second conduit bore 34 or the input opening 36 may flare outwardly to have a wider dimension at its end than the width of the output conduit bore 24. The second conduit assembly 32 includes a fourth sealing surface 38 adjacent to and surrounding the input opening 36. The fourth sealing surface 38 of the second conduit assembly 32 is configured to conform with the dimensions of the second sealing surface 20b of the central containment member 12. When the second conduit assembly 32 is tightened to fully engage the central containment member 12 the second sealing surface 20b of the central containment member 12 and the fourth sealing surface 38 of the output conduit assembly 32 are compressed together around the second porous membrane 40 to form a flow resistant seal around the periphery of the second porous membrane 40. The second fluid contact area 43 of the second porous membrane 40 is free to receive a flow of fluid from the first containment bore 14 into the input opening 36 of the second conduit bore 34. Similar to the first conduit assembly 22, the second sealing surface 20b and the fourth sealing surface 38 may be used in conjunction with a compressible ring, or may be flat, or may be formed of corresponding shapes to compress the second porous membrane 40 around the periphery to form a fluid sealed area.

The μSPE cartridge 10 is optionally further configured at the distal ends to engage a conduit fitting assembly 48. The conduit fitting assembly 48 is engaged with the conduit assemblies 22, 32 with any type of suitable connector mechanism, such as intermeshing threads as depicted in FIG. 1. The conduit fitting assembly 48 includes a conduit fitting 49 for positioning an external fluid conduit 50 at a defined position within the conduit fitting assembly 48. In the embodiment depicted in FIG. 1, the external conduit 50 is a capillary 52. In other embodiments, as depicted in FIG. 4, the external conduit 50 may be a syringe needle 56 or length of flexible tubing 58. The conduit fitting assembly 48 is designed to position a proximal portion 53 of the external conduit 50 down into the conduit bores 24, 34 of the conduit assemblies 22, 32. In this case, fluid flows through the external conduits 50 and does not contact the conduit bores 24, 34 except at the end openings 26 and 36. These embodiments are particularly useful for handling sample volumes in the range of 0.1 to 100 μl, because capillaries, microsyringe needles and tubing is commonly available to accommodate such small sample volumes and there is no further dilution of the sample by spreading it out to fill the full volume of the conduit bores 24 and 34.

In another embodiment, the first and second conduits bores 24, 34 of the first and second conduit assemblies 22, 32 may be used directly as fluid conduits for input and output of a fluid sample through the μSPE device. In such embodiments, the conduit fitting 49 is adapted to engage the external conduit 50 at the distal ends 25, 27 of the fluid conduit bores 24, 34. The sample is introduced into the distal end 25 of the first conduit assembly and flows directly in contact with the first fluid conduit bore 24, through the first containment bore 14, and outwardly in direct contact with the second conduit bore 34. In such cases, the conduit fitting 49 may be any type of suitable connector fitting such as a Luer type fitting 47, or other fittings such as syringe connectors or tubing connectors and the like as exemplified FIGS. 4A-4C. In other embodiments, the distal ends 25, 27 may be configured with an external threaded screw 51a adapted for coupling the conduit assembly 22 into a correspondingly threaded external receptacle as illustrated in FIG. 4D. The distal ends 25, 27 may of course, be configured in reverse, with an external threaded receptacle 51b adapted for coupling to an external threaded screw as depicted in FIG. 4E.

The component parts of the μSPE cartridge devices provided herein may be made of any suitable material that enables sealing on the surfaces when the pieces are tightened together. Suitable materials include, but are not limited to polyetheretherketone (PEEK), polycarbonate, polypropylene, and stainless steel). In a typical embodiment, the component parts are made of PEEK.

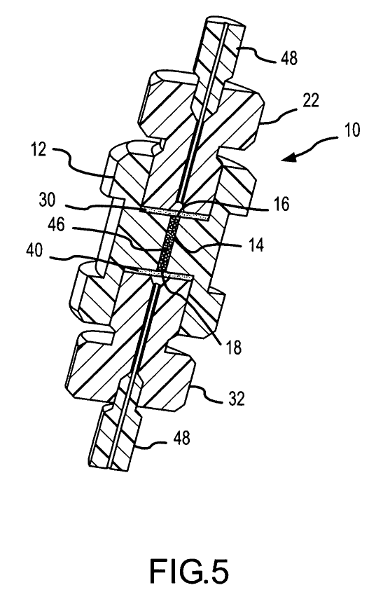

FIG. 5 shows a μSPE cartridge 10 fully assembled, including the conduit fittings 48 and solid phase material 46 packed in the first conduit bore 14. The purpose of the first containment bore 14 is to enclose and contain the solid phase material 46 between the first porous membrane 30 and the second porous membrane 40. The solid phase material 46 material can be any material that binds, absorbs, retards or otherwise interacts physically or chemically with a component of a sample that passes over or through the solid phase material 46. The interacting component of the sample may be inorganic or organic and may be a solute, a solvent, a solid, or a particulate component such as a biological cell, virus or macromolecular aggregate. Example solid phase materials 46 include any known or yet to be developed chromatographic or biological medium having a solid component, including, but not limited to, particles—such as silica and charcoal, resins—such as hydrophilic ion exchange or hydrophobic resins, porous beads—such as molecular size exclusion beads, magnetic beads, integrated solid phase channels, and functionalized derivatives of the same that include a ligand, a receptor, a protein, or other chemical moiety that interacts with a component of the sample. Other solid phase materials 46 may include biological materials, such as cells, viruses, membranes, macromolecular aggregates and the like. Also included within the meaning of solid phase material 46 are macromolecular solutes that are dissolved, or at least partially dissolved, in a solvent and that has a molecular size larger than the pore size of the first and second porous membranes 30, 40. Examples of such macromolecular solutes include polymers such as cellulose, polyethylene glycol, high molecular weight DNA, polyacrylamide, methacrylate and the like. Typical porous polymer monoliths known in the art are also useful for the solid phase material 46. In short, any material too large to pass through the pores of the first and second porous membranes 20, 40 is suitable for use as solid phase material 46 in the μSPE devices provided herein

Accordingly, the first porous membrane 30 and the second porous membrane 40 are selected to have a pore size that is small enough to prevent passage of the solid phase material 46 through the pores. The pore size is also selected to be large enough to allow passage of components of the sample that are to interact with the solid phase material 46 contained within the first containment bore 14. The first and second porous membranes 30, 40 should be made of a material that can withstand the pressure applied on the membranes to move the sample through the μSPE device. In certain uses, the sample is moved through the μSPE device using hydrostatic pressure such as applied by a pump or syringe. At one extreme, high performance liquid chromatography (HPLC) pumps that deliver pressures up to 2000 psi are used. In such high pressure embodiments, the first and second porous membranes 30, 40 should be made of a material suitable to withstand such pressures across the first and second fluid contact areas 31, 41, respectively. Suitable membrane materials for such embodiments include, but are not limited to, nitrocellulose, cellulose acetate and nylon membranes. Membranes made of such materials are available in a variety of pore sizes. At the other extreme, in certain applications the sample is moved electrophoretically and/or electroosmotically by application of an electrical field across the μSPE. In these embodiments, the pressure on the membranes is primarily electro-osmotic with little hydrostatic component. In such embodiments, the first and second porous membranes 30, 40 may be made of less pressure resistant material, such as the semi-porous membranes used for dialysis tubing. Dialysis membranes, may, of course, be used in any other embodiment where the pressure is sufficiently low to prevent rupture of the dialysis membrane.

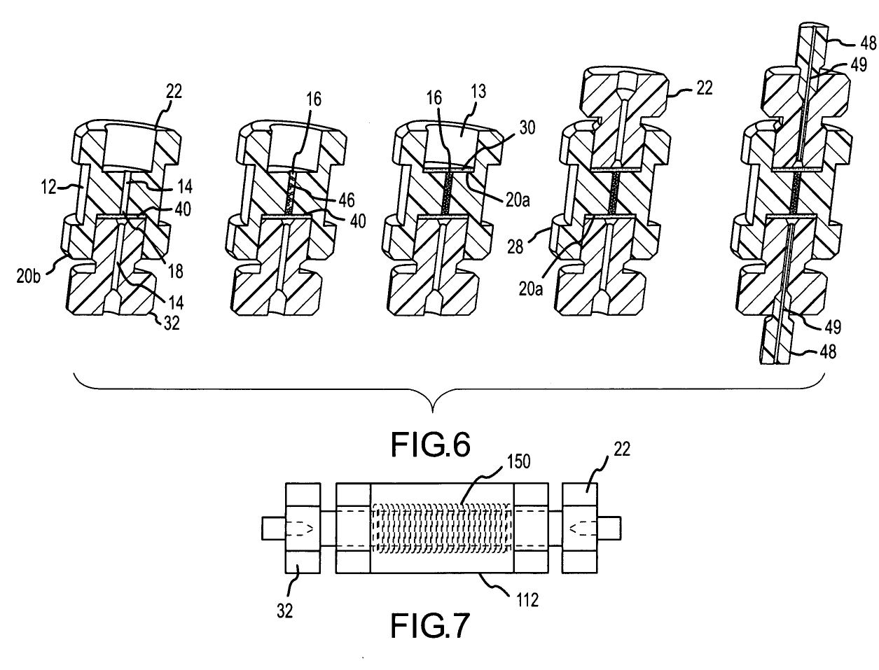

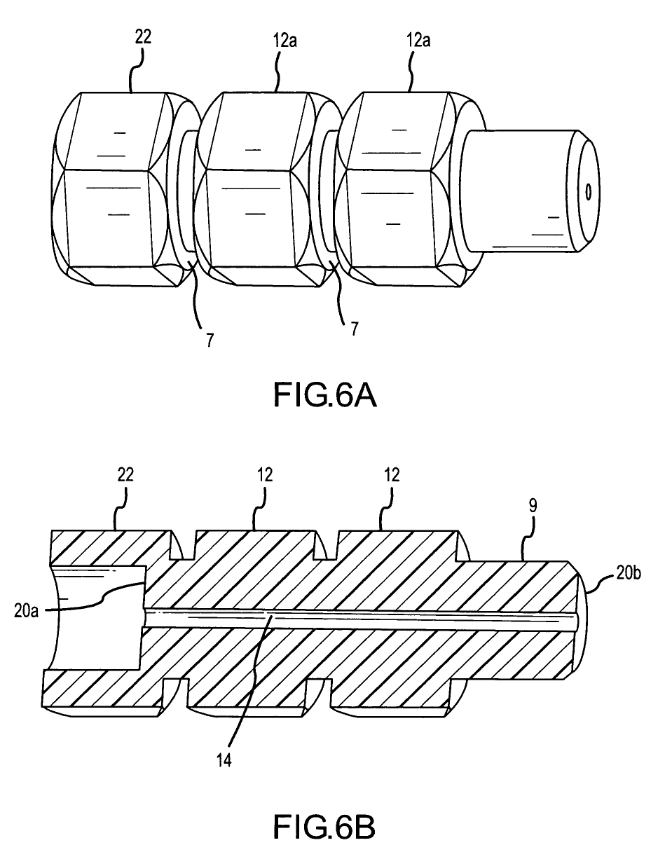

FIG. 6 illustrates steps in the assembly of the μSPE cartridge 10 and loading of the solid phase material 46 into the first containment bore 14. The second porous membrane 40 is positioned beneath the output end 18 of the first containment bore 14 in contact with the second sealing surface 20b of the central containment member 12. The second conduit assembly 32 is then engaged with the lower distal end 36 of the central containment member 12 and tightened to compress the peripheral area 41 of the second porous membrane 40 between the second sealing surface 20b of the central containment member 12 and the fourth sealing surface 38 of the second conduit assembly 32. The solid phase material 46 is then introduced into the input end 16 of the first containment bore 14. To facilitate packing of the solid phase material 46 into the first containment bore 14 a vacuum may be drawn from the bottom of the second conduit assembly 32 through the first containment bore 14 while loading the solid phase material 46.

When the first containment bore 14 is filled with solid phase material 46, excess material is removed from the first sealing surface 20a of the central containment member 12 and the first porous membrane 30 is placed over the input end 16 of the first containment bore 14 on the first sealing surface 20a. The first conduit assembly 22 is then engaged with the upper distal end 13 of the central containment member 12 and tightened to compress the peripheral area 31 of the first porous membrane 30 between the first sealing surface 20a of the central containment member 12 and the third sealing surface 28 of the first conduit assembly 32. The above procedure can of course be reversed in order with respect to which membrane and which conduit assembly is first positioned in the central containment member 12. Moreover, instead of using a vacuum to draw the solid phase material 46 downward into the first containment bore 14, a pump may be used to push the solid phase material 46 upward through the first containment bore 14 against the first porous membrane 30. Once the μSPE has been loaded with solid phase material 46 and assembled, the external conduit fitting assemblies 48 are engaged at the distal ends 13, 15 of the first and second conduit assemblies 22 and 32 and the device is ready for use.

One of the most typical uses for the μSPE cartridges 10 will be to bind a dilute sample to a suitable ion exchange or hydrophobic solid phase material 46 and then to elute the sample in a small volume to thereby concentrate the sample. In this geometry, the volume of the input sample is not relevant so long as the binding capacity of the solid phase material 46 is sufficient to bind the desired amount of components present in the sample. The μSPE cartridges 10 may also be used for microscale “desalting” or other size exclusion applications. For such uses, it is typically desirable to use a first containment bore 14 having a length that is greater than its diameter, and it is desirable to use sample input volume that is substantially less (e.g., at least 5 fold less) than the volume of the first containment bore. Thus, for example, a user may select a first central containment member 12 having a 20 μl first containment bore 14 that is configured with a dimensions appropriate for concentrating a sample, or select a second central containment member 12 with a 20 μl containment bore 14 configured with dimensions for desalting, which dimensions would be relatively “longer and thinner” than the first containment member although containing the same volume.

In certain embodiments, a plurality of central containment members 12 can be assembled together to lengthen the overall length of the containment bore 14. FIGS. 6A and 6B depict one example of such an embodiment in external and cut-a-away isometric view, respectively. In this embodiment, a first central containment member 12a is coupled to a second central containment member 12b via containment member coupling elements 7. The containment member coupling element 7 may be any element or combination of elements, such as threaded couplings, suitable for forming a fluid tight coupling between the containment members 12a, 12b. In the particular embodiment shown in FIGS. 6A and 6B, the first central containment member 12a is show connected to the conduit assembly 22 and the second central containment member is shown without coupling to the conduit assembly 22. The first sealing surface 20a of that will contact the first porous membrane 30 is on the end of the first containment member 12a, while the second sealing surface 20b that will contact the second porous membrane 40 is on the end of the second central containment member 12b. The second containment member 12b, as depicted, has an elongated bore portion 9. Thus, a single containment bore 14 of elongated dimensions is formed by coupling the plurality of central containment members 12a and 12b. A kit can be provided having a plurality of central containment members of the same or a plurality of different dimensions along with a plurality of coupling assemblies 7, so that user may form μSPE cartridges 10 of various lengths by assembling multiple central containment members in a line.

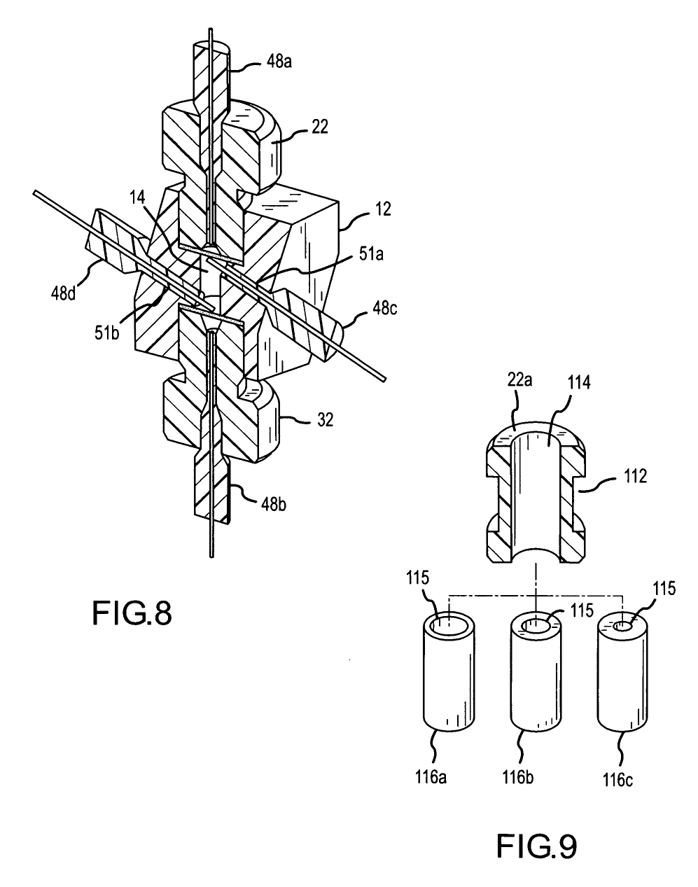

Temperature can either promote or adversely effect the binding and elution of various analytes to various solid phase materials 46. Accordingly, in another aspect, as depicted in FIG. 7, certain embodiments of the μSPE devices proved herein include a heat transfer element 150 incorporated therewith to heat or cool the solid phase material 46 (and sample) in the first containment bore 14. In such embodiments, the central containment member 12 of the μSPE cartridge device 10 is preferably made of a material with a high heat capacity, such as aluminum or other metal. The heat transfer element 150 includes a medium that conducts heat, and is coiled around or integrated within, the walls of the central containment member 12. One example of a suitable heat conducting medium is an electrical coil that heats the central containment member 12 upon application of an electrical current. Another example of a suitable heat conducting medium is a hollow coil through which a heated or refrigerated fluid is passed. The heat is transferred between the central containment member 12 and the heat conducting medium according to the temperature gradient between the first containment bore 14, the central containment member 12 and the heat transfer element, therefore the temperature in the first containment bore 14 can be heated or cooled depending upon the temperature of the heat conducting medium in the heat transfer element 150. In one example use, cells captured in the solid phase material 46 in the first containment bore 14 can be rapidly lysed after binding to the solid phase material 46 by bringing the heat transfer element 150 to a suitable lysing temperature, for example about 90° C. for 2 minutes. Detergent or other chemical agent to assist cell lysis may be introduced into the first containment bore 14. FIG. 8 illustrates another embodiment of the μSPE cartridge 10, which includes lateral conduit fitting assemblies 48c and 48d that fit into lateral bores 51a, 51b formed in the central containment member 12 so that electrodes may be introduced into the first containment bore 14 to assist high-voltage lysing the cells bound to the solid phase material 46 contained therein.

Because the μSPE cartridge device 10 is modular and can be assembled and disassembled with ease, the same device can be reused on multiple occasions and can be packed with different solid phase materials 46 and integrated with different systems. The volume of the first containment bore 14 for any μSPE cartridge is pre-set because it is determined by the dimensions of the first containment bore 14 which is permanently formed in the central containment member 12. One commercial embodiment of the μSPE includes a kit that contains at least one set of the first and second conduit assemblies, 22, 32, at least one set of the conduit fitting assemblies 48 for the first and second conduit assemblies, and a plurality of central containment members 12 having first containment bores 14 of a plurality of different volumes. The user selects the appropriate central containment member 12 having an internal volume appropriate for the sample size or procedure being used.

Another embodiment of a kit includes a set of the first and second conduit assemblies, 22, 32, a set of the conduit fitting assemblies 48, and a central containment member 12 where the first containment bore 14 is adapted to contain a plurality of volume adapters, each having a second containment bore different volumes. A central containment member 112 configured for receiving volume adapters 116a-c is illustrated in FIG. 9. The central containment member 112 is the same as the central containment member 12 depicted in FIG. 1, except that the first containment bore 114 has a wider internal diameter than the first containment bore 14 depicted FIG. 1. Each of the volume adapters 116 is configured as a cylindrical barrel with an exterior diameter adapted to correspond to the internal diameter of the first containment bore 114. The volume adapters 116a-c each have a second containment bore 115 of different dimensions. The assembly of the μSPE device with the volume adapters 116 is the same as the assembly of the device depicted in FIG. 6, except that one of the volume adapters 116 is inserted into the first containment bore 14 prior to placement of the first porous membrane 30. The volume adapters may be held in place in the first containment bore 114 merely by frictional contact, or in other embodiments, the interior of the first containment bore 114 and the exterior of the volume adapters may be configured with corresponding threads so that the volume adapter can be screwed into position within the first containment bore 14. The user selects the appropriate volume adapter having a second containment bore 114 with an internal volume appropriate for the sample size or procedure being used.

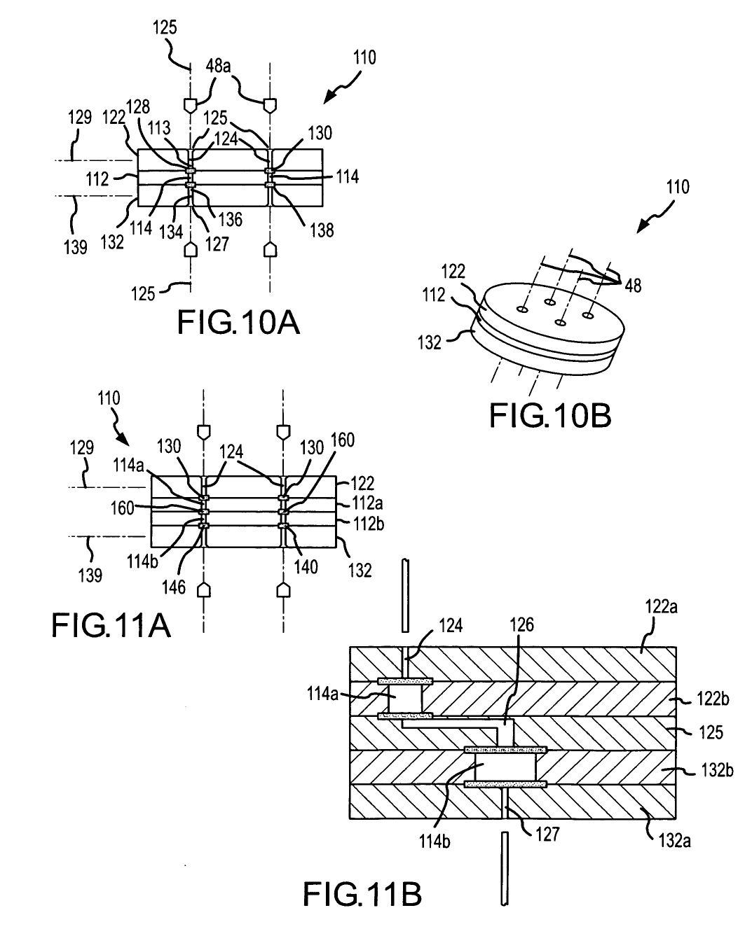

FIG. 10 depicts another embodiment of a μSPE device, which is configured as a chip device 110. FIG. 10a is a cut away side view and FIG. 10b is an isometric view. Unlike the cartridge device 10 depicted in FIG. 1, the chip device 110 is not modular, but rather is permanently bonded together. The chip μSPE device 110 includes a first planar wafer 122 having at least one, but in typical embodiments, having a plurality of input conduit bores 124 formed between top and bottom surfaces of the first wafer. The input conduit bores 124 have a longitudinal axis 125 oriented transversely to a plane 129 of the first wafer 122 and are analogous in structure and function to the first conduit bores 24 in first conduit assembly 22 of the μSPE cartridge device 10. The input conduit bores 124 have a first opening 125 at an external end adapted to be used as-is or have connecting tubing mounted, or glued directly in the conduit bore, or to receive a conduit fitting assembly 48a and has a second opening 113 at an internal end to emit a flow of fluid. The second opening 113 is surrounded by a first sealing surface 128 adjacent the second opening 113.

The chip μSPE device 110 further includes a second planar wafer 132 having at least one, but in typical embodiments, having a plurality of output conduit bores 134 formed between top and bottom surfaces of the second wafer 132. The output conduit bores 134 each have a longitudinal axis 125 oriented transversely to a plane 139 of the second wafer 122 and are analogous in structure and function to the second conduit bores 34 in the second conduit assembly 32 of the μSPE cartridge device 10. The output conduit bores 134 have a first opening 136 at an internal end adapted to receive a flow of fluid, and an second opening 127 at the external end adapted to receive a conduit fitting assembly 48b. The first opening 136 is surrounded by a second sealing surface 138 adjacent the second opening 136.

A third planar wafer 112 is sandwiched between the first wafer 122 and the second wafer 134. The third planar wafer 112 is analogous to the central containment member 12 of the μSPE cartridge 10, and includes a containment bore 114 disposed therein with an input opening 116 and an output opening 118 surrounded by adjacent sealing surfaces 120a and 120b. The sealing surfaces 120a and 120b are adapted to conform in size and correspond to the location to the first and second sealing surfaces 128 and 138 when the chip μSPE device 110 is assembled. A first porous membrane 130 is disposed between the sealing surface 120a and first sealing surface 128 and a second porous membrane 140 is disposed between the sealing surface 120b and the second sealing surface 138. The porous membranes 130, 140 are typically dimensioned to be slightly larger than the input and output openings 116 and 118 to fit onto the adjacent the sealing surfaces 120a and 120b. A solid phase material 46 is packed into the containment bore 114 and enclosed by the first and second porous membranes as with the μSPE cartridge device 10.

The first wafer 122 and the second wafer 134 are oriented so the that the longitudinal axes 125 of the input conduit bores 124 and output conduit bores 134 are aligned with the containment bore 114 of the third wafer, which also aligns the first sealing surface 128 of the input bore 124 with the sealing surface 120a of the third wafer and the second sealing surface 138 of the output bore 114 with the sealing surface 120b. In one embodiment, the sealing surfaces 120a and 120b, and 128 and 138 are each flat. In another embodiment the corresponding sealing surfaces 120a and 128 or 120b and 138 are formed of a correspondingly fitting shapes, such as the annular ridge 35 and channel 37 depicted in FIG. 3, so that when the first and second and third wafers 122, 132 are compressed and bonded together with the third wafer 112 disposed therebetween with the first and second porous membranes 130, 140 in position, the corresponding sealing surfaces 120a and 128 or 120b and 138 compress a peripheral zone of the porous membranes 130, 140 between the correspondingly fitting surfaces. In another embodiment, an “O” ring seal may be used.

The wafers 122, 124, and 112 are bonded together using heat or an appropriate adhesive to hold the wafers together with sufficient force to maintain the fluid resistant seal between the corresponding sealing surfaces 120a and 128 or 120b and 138. In use, the conduit assemblies 48 are engaged with the distal ends of the input and output bores 124, 134 and a sample is introduced into the input bore 124 via the conduit fitting assembly 48a and eluted from the output bore 134 from the corresponding conduit fitting assembly 48b.

The wafers 122, 124, and 112 can be made of any plastic materials that can be chemically or thermally bonded together such as polycarbonate, polypropylene, cycloolefins.

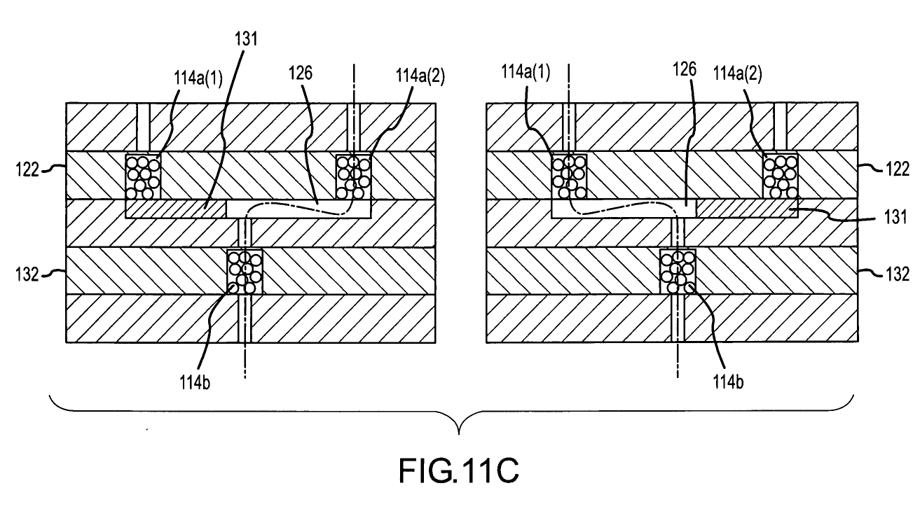

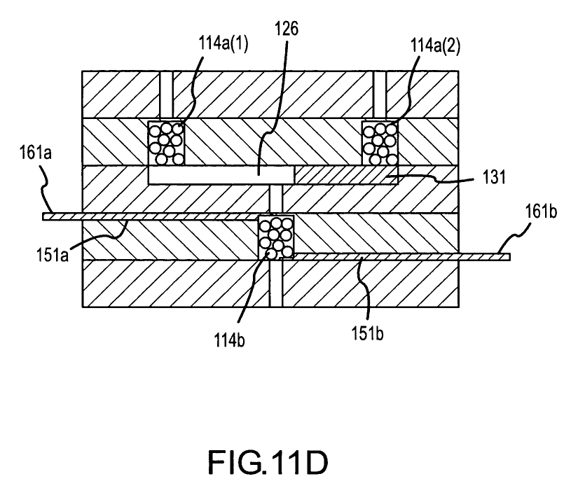

One advantage of the wafer μSPE device 110 is that multiple central containment wafers 112a, 112b with multiple containment bores 114a, 114b can be stacked between the first and second wafers 122, 134 as illustrated in FIG. 11A. In such embodiments, each of the stacked containment wafers 112a, 112b include a different solid phase material 46a, and 46 packed in the containment bores 114a and 114b. These embodiments include a third porous membrane 160 positioned between the first sample bore of the third wafer and the separate sample bore of the next stacked wafer wafer. The sample containing analytes passes directly from the first solid phase material 46a through the third porous membrane 160 into the second solid phase material 146b and out through the second porous membrane 140b, thereby affecting a two phased separation of analytes in a single application.

In an alternative embodiment, as depicted in FIG. 11B, one or more of the containment bores 114a in the first wafer 122 can be interconnected with a second containment bore 114b in the second wafer 132 via an intervening wafer 125 having a microfluidic channel 126 configured therein. This embodiment is useful, for example, for combining the output from a plurality of the first wafers having a first type of absorbent material, into a single second wafer having a different type of absorbent material, and directing the output to a single output bore 127. FIG. 11B also illustrates another configuration for forming the first and second wafers 122 and 132. These wafers are formed in two layers, a first layer 122a, 132a is configured with the input bores and output bores 124, and 127, respectively, and a second layer 122b, 132b is configured with the containment bores 114a and 114b, respectively. FIG. 11C shows a variation of the embodiment depicted in FIG. 11B that is useful for alternately sending an output flow from different first containment bores 114a in the first wafer 122 to a common second containment bore 114b in the second wafer 132. In this embodiment, a moveable valve-like piston element 131 is provided in a microfluidic channel 126 positioned between adjacent first containment bores 114a(1) and 114a(2). When fluid flows from a first one of the first containment bores 114a(1) the valve-like piston element 131 is pushed away from that first containment bore, thereby opening a passage for flow of fluid from that first containment bore 114a(1) through to the second containment bore 114b while blocking passage of fluid from the adjacent first containment bore 114a(2). When fluid flows from the other of the adjacent containment bores 114a(2) the valve-like piston element operates in reverse to open the passage from the second adjacent first containment bore 114a(2) while closing the passage from the first adjacent containment bores 114(a)(1). In this way, the flow of fluid through to the common second containment bore 114b can be alternatively and sequentially controlled simply by selection of which of the adjacent first containment bores 114(a)(1) or 114a(2) from which to urge the flow of fluid.

Any of the embodiments of chip devices 110 described herein can also be configured to lyse cells that are concentrated within any of their respective containment bores 114. FIG. 11D illustrates one such embodiment. In this example, two lysing electrodes 161a and 161b are introduced into lateral bores 151a and 151b in the wafer 132, respectively. The lysing electrodes 161a and 161b are thereby positioned with an electrically-conductive path running across the second containment bore 114b. Cells that are concentrated in the second containment bore 114b can thereby be lysed by application of an appropriate electric field between the electrodes 161a and 161b. While FIG. 11D illustrates a configuration with dual levels of first 114a and second 114b containment bores, it is understood that the same type of electrode configuration can be used with a single layer of containment bores 114a, or for lysing contents in both layers of containment bores 114a, 114b, using any of the various μSPE chip type devices described herein.

Alternatively, if heat lysis is desired, the electrodes 161a and 161b can be replaced with a heat conductive medium. The heat conductive medium may optionally take the form of a new layer of heat conductive material formed between the wafer layers or may be placed in channel formed in the wafer in shape configured to receive the heat conductive medium.

Samples can be loaded into the wafer or cartridge μSPE devices provided herein by positive pressure into the input bores 124, or by negative pressure by drawing a vacuum from the output bores 127. It has been found that use of a vacuum facilitates multiple sample preparation using wafer devices better than use of positive pressure while simplifying assisting instrumentation.

Because the μSPE devices provided herein are inexpensive, re-useable, and adaptable for use with different solid phase materials and they can be configured singularly, multiply with a wide variety of microscale analytical and preparative systems, either automated or manually operated. In essential form, such a system would include the μSPE device, a sample input device, and an analytical instrument configured to analyze the sample eluted from the μSPE device. Suitable analytical instruments include, but are not limited to spectrophotometers, fluorimeters, micro HPLC systems, gas chromatography systems, mass spectrometers, GC-mass spectrometer systems, and capillary electrophoresis systems.

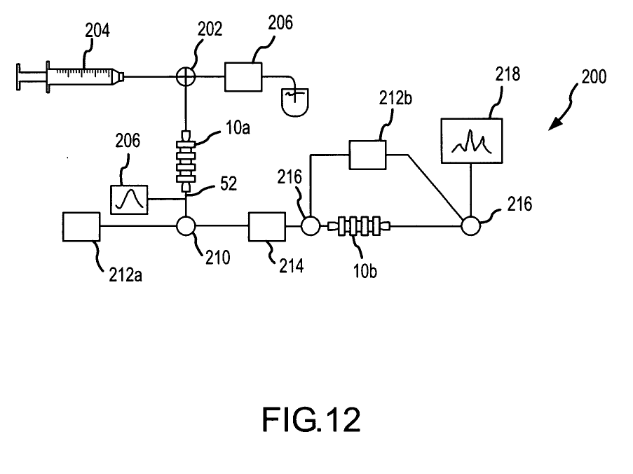

FIG. 12 illustrates an example of such a system 200 for cell retention, concentration and lysis. The system includes a first three-way valve 202 connected at the first port to a sample input syringe 204, connected at the second port to a pump 206, and connected at the third port to a first μSPE cartridge 10a. The three-way valve 202 is first set to direct the flow of sample from the syringe into the first μSPE cartridge 10a. The effluent fluid from the output capillary 52 is detected by a first analytical instrument (e.g., a spectrophotometer 206) configured to detect light absorbption through a clear detection zone of the capillary. A second three-way valve 210 is positioned after the detection zone and is initially set to direct the effluent to a first waste 212a. After washing the first μSPE cartridge 10a to remove non-binding material, the first three-way valve 202 is set to direct a flow of eluting solvent from the pump to the first μSPE cartridge to elute bound cells from the first μSPE cartridge 10a. The second three way valve 210 is then set to direct the eluted effluent to a cell lysing chamber 214. The contents of the lysed cells proceed through a third three way valve 216 to a second μSPE cartridge 10b containing a different solid phase material 46 to bind proteins in the cell lysate. Certain proteins bind to the second μSPE cartridge 10b while other components pass through a fourth three way valve 216 set to direct the effluent to a second waste 212b. The third three-way valve is then set to direct a second eluting solvent through the second μSPE cartridge 10b to release and concentrate the bound proteins. The fourth three way valve 216 is then set to direct the bound proteins to a micro HPLC system 218 where they are separated and analyzed.

### EXAMPLE 1

### Concentration and Purification of BSA with a 5 μl μSPE Cartridge

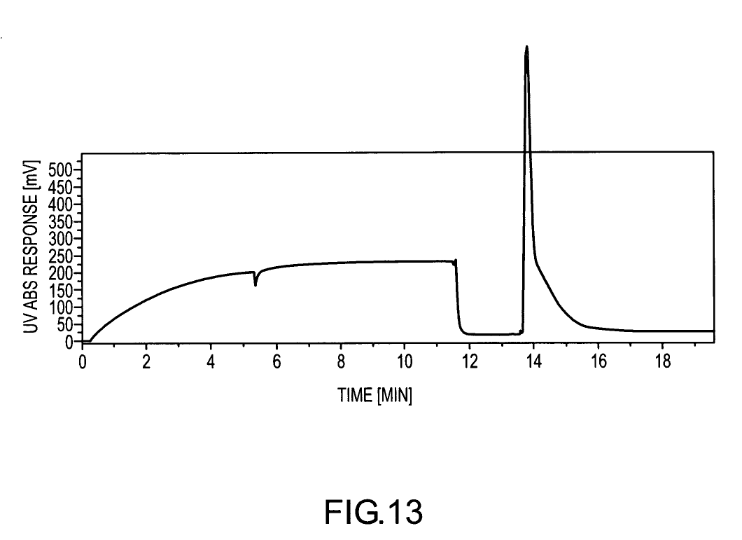

FIG. 13 illustrates an example use of the μSPE cartridge 10 to concentrate and purify a sample protein. The containment bore 14 in cartridge 10 was packed with 5 μl of anion exchange beads containing DEAE (Toyo Pearl DEAE TSK from Tosoh Biosciences, Montgomeryville, Pa.) and tested for protein concentration. The cartridge was connected on one end to a syringe filled with 1 mM bovine serum albumin (BSA) in 5 mM borate buffer and to the other end to a fused silica capillary that was mounted in a UV detection setup. As the syringe delivers through the cartridge the BSA solution at a 10 μl/min flow rate, the absorbance of the solution that exits the cartridge is recorded by the UV detector. The breakthrough curve illustrates indirectly the amount of sample retained on the cartridge. As solution is passed through the cartridge part of the BSA is retained while the unretained BSA exits the cartridge and is recorded at the detector. As the surface of the adsorbent material is gradually saturated, BSA is no longer retained, and the recorded UV signal reaches a plateau which corresponds to the absorbance of the 1 mM BSA solution. FIG. 13 depicts the gradual increase in unretained BSA signal, which reaches maximum after approximately 6 minutes.

In a following step, the cartridges was subsequently rinsed with DI water for 2 min and the signal dropped to zero as BSA was no longer present in the capillary. In step 3, a 200 mM NaCl 5 mM borate pH 8.5 solution was passed through the cartridge to cause desorption of the BSA retained on the cartridge. As BSA is released from the adsorbent material, a tall peak was recorded and the concentration capability of this packed cartridge was demonstrated. FIG. 13 is a chromatogram over time showing loading of the sample and elution of the BSA. The BSA eluted from the DEAE beads in a sharp peak with about 50% of the BSA eluting in the first 5-10 μl of eluting buffer. The relatively sharp sample peak of BSA illustrates rapid elution with little dilution of the sample because the peak emerged in a total volume about equal to the volume of DEAE of material packed in μSPE cartridge 10.

### EXAMPLE 2

### Protein Concentration Using 2 μl and 5 μl μSPE Cartridges Packed With Different DEAE or Hydrophobic Resins

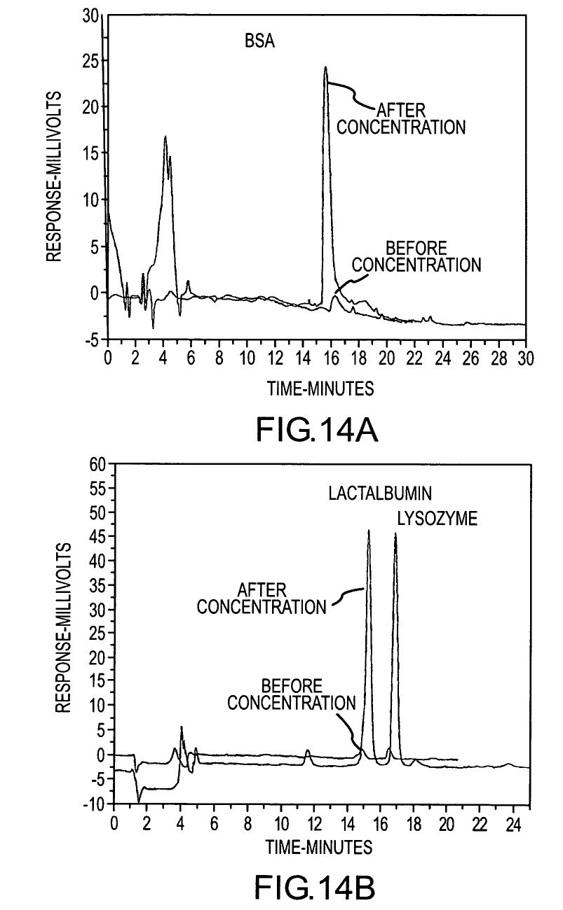

5 μl of a crude sample of BSA was injected in a microHPLC system to asses the amount of BSA present in the sample column. The lower U.V. absorbption chromatogram in FIG. 4A shows detection of a small peak of BSA at the expected position after 10 minutes of elution. 1 ml of the same crude sample was then treated by passing the entire contents through the first sample bore of a μSPE cartridge containing 2 μl of packed Toyo Pearl DEAE 650S and eluted with 200 mM NaCl into a 5 μl sample. The 5 μl sample was then subject to the same chromatographic analysis over the microHPLC reverse phase to generate the upper chromatographic trace. Comparison of the upper trace to the lower trace in FIG. 14A illustrates that the BSA was concentrated about 20 fold using the 2 μl SPE cartridge.

FIG. 14B illustrates concentration of a mixture of lactalbumin and lysozyme by treatment though a 5 μl μSPE cartridge 10 packed with the hydrophobic solid substrate Toyo Pearl Phenyl 650S. A second experiment was designed to quantify the concentration ratios that can be achieved with the microliter-volume SPE cartridges. A microHPLC system was used to determine the amount of proteins present in the solutions. In particular, the protein samples were injected in the microHPLC setup, the analytes were separated on a reverse phase column and their UV absorbance was recorded. The area of the corresponding peaks is proportional to the amount of analyte present in the sample. A diluted solution of 10⁻⁷ M lysozyme and 2×10⁻⁷ M lactalbumin was made in 200 mM (NH₄)₂SO₄, 5 mM borate buffer. This sample was injected in the microHPLC and the recorded signal is presented in FIG. 14B (lower trace). A 5 μl volume SPE cartridge was packed with ToyoPearl Phenyl (Tosoh Bioscience LLC, Montgomeryville, Pa.). 1 ml of the lysozyme and lactalbumin solution was passed through the cartridge at a 20 μl/min flow rate and the proteins were retained on the adsorbent material. The cartridge was subsequently rinsed with 15 μl of 5 mM borate buffer, also at 20 μl/min flow rate, and the obtained sample was analyzed in the microHPLC system (upper trace in FIG. 14B). By comparing the areas of the protein peaks in the solutions with known concentration of proteins (standards) with the areas recorded from the sample collected after concentration, it was calculated that lysozyme and lactalbumin concentrations were 4×10⁻⁶ M and 10 ⁻⁵ M, respectively. This corresponds to 40 times concentration (about 60% protein recovery) in the case of lysozyme and about 75% for lactalbumin. In subsequent experiments larger volumes of samples were flushed through the cartridge and, as a result, concentration ratios as high as 150 fold have been recorded.

### EXAMPLE 3

### Reproducibility of the Same μSPE Cartridge

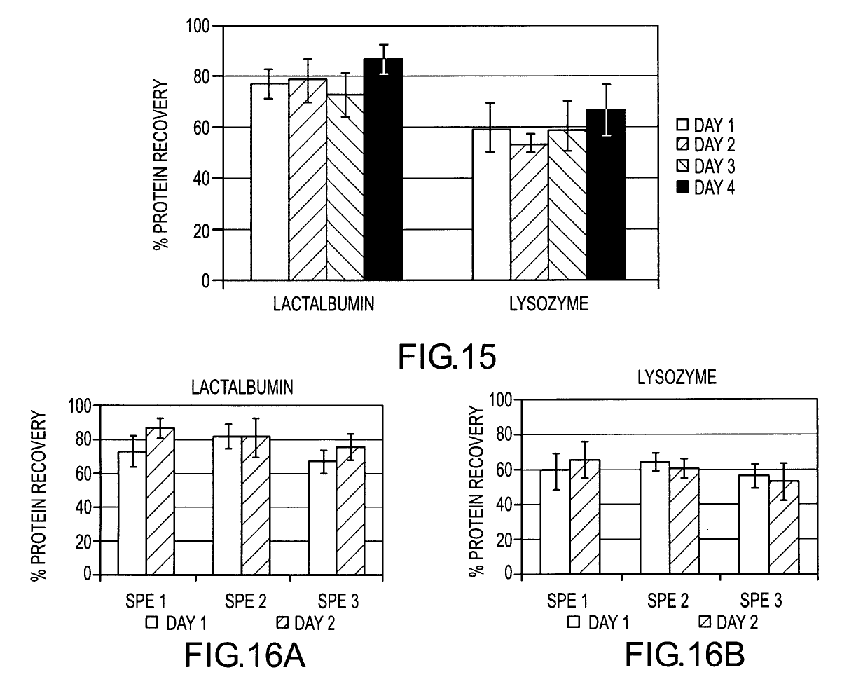

To test whether the μSPE cartridges provided herein are reusable and reliable over a period of time, the same procedure for concentrating and analyzing lactalbumin and lysozyme samples depicted in FIG. 14B and described in Example 2 was repeated using the same μSPE cartridge. Between uses, the μSPE cartridges were washed with 0.20 ml a washing buffer and reconditioned with 0.20 ml of the binding buffer. As illustrated in FIG. 15, the same μSPE cartridge showed reproducible recovery of about 70% of the input lactalbumin and about 60% of the input lysozyme.

### EXAMPLE 4

### Reproducibility Between Different μSPE Cartridges

To determine whether μSPE cartridges containing the same volume and type of packed absorbent material in different cartridges would perform similarly, three different 5 μl SPE cartridges were separately loaded with Phenyl 650S resin used to concentrate lactalbumin and lysozyme as in Example 2. Each cartridge was tested for reproducible performance, and the performance of each cartridge was compared to one another. FIG. 16 demonstrates that there was no significant difference in the recovery of lactalbumin and lysozyme between different cartridges, or with the same cartridge on different days.

What is claimed is:

1. A device for microliter scale treatment of fluid samples, comprising,
a central containment member having a first containment bore disposed therethrough with openings at input and output ends of the first containment bore and where the input and output ends of the first containment bore are surrounded by first and second sealing surfaces adjacent to the input and output ends, respectively,
a first conduit assembly having a first conduit bore disposed therethrough with a first opening of the first conduit being surrounded by a third sealing surface adjacent to the first opening;
a second conduit assembly having an second conduit bore disposed therethrough with an second opening of the second conduit being surrounded by a fourth sealing surface adjacent to the second opening;
a first porous membrane sealingly engaged between the first sealing surface of the first containment bore and the third sealing surface of the first conduit assembly so that a perimeter of the first porous membrane is sealed from fluid flow while a first fluid contact area of the first porous membrane is disposed between the input opening of the containment bore and the first opening of the first conduit; and
a second porous membrane sealingly engaged between the second sealing surface of the first containment bore and the fourth sealing surface of the second conduit assembly so that a perimeter of the second porous membrane is sealed from fluid flow while a second fluid contact area of the second porous membrane is disposed between the output opening of the containment bore and the second opening of the second conduit, and the volume of the containment bore is enclosed at the input and output ends by the first and second fluid contact areas of the first and second porous membranes.

2. The device of claim 1 further including a solid phase material enclosed in the containment bore.

3. The device of claim 2 wherein the solid phase material is an analyte absorbing material.

4. The device of claim 2 wherein the solid phase material is porous size exclusion resin.

5. The device of claim 1 wherein the first containment bore is fitted with a volume adapter having an outer dimension configured to fit within the first containment bore, and having a second containment bore that contains a smaller volume than the first containment bore.

6. A kit including the device of claim 5 and including a plurality of volume adapters with a plurality of a second containment bores containing different smaller volumes than the first containment bore.

7. The device of claim 1 further including a conduit fitting assembly adapted to interconnect an external fluid conduit to at least one of the first and second conduit assemblies.

8. The device of claim 7 wherein the external fluid conduit is a capillary.

9. The device of claim 8 wherein a portion of the capillary extends into at least one of the first and second conduit bores.

10. The device of claim 7 wherein the external fluid conduit is a syringe needle.

11. The device of claim 7 wherein the external fluid conduit is a flexible tube.

12. The device of claim 1 wherein at least one of the first and second conduit assemblies includes connector fitting for removably engaging and disengaging the conduit assembly with the central containment member.

13. The device of claim 12 wherein the connector fitting includes intermeshing threads for engaging the conduit assembly with the central containment member.

14. The device of claim 1 wherein at least one of the first and second conduit bores is configured to taper from a wider first diameter at external ends of the conduit bore to a smaller second diameter of the conduit bore.

15. The device of claim 1 wherein at least one of the first and second conduit bores is configured to taper from a smaller first diameter of the conduit bore to a wider second diameter that contacts the fluid contact area of at least one of respective first or second membranes.

16. The device of claim 1 wherein the volume of the containment bore is 100 μl or less.

17. The device of claim 1 where in the volume of the containment bore is 50 μl or less.

18. The device of claim 1 wherein the volume of the containment bore is 10 μl or less.

19. The device of claim 1 wherein the volume of the containment bore is 5 μl or less.

20. The device of claim 1 wherein the volume of the containment bore is 1 μl or less.

21. The device of claim 1 further including a heat conducting medium surrounding or embedded in the central containment member to heat or cool the containment bore.

22. The device of claim 21 wherein the heat conducting medium is an electrical coil.

23. A device for microliter scale treatment of samples, comprising,
a first planar wafer having an input conduit bore with a first longitudinal axis longitudinally disposed in and transverse to, a first plane of the first wafer, the input conduit bore having an input end and an output end with a first sealing surface surrounding the output end of the input bore;
a second planar wafer having output conduit bore with a second longitudinal axis longitudinally disposed in and transverse to, a second plane of the second wafer, the output conduit bore having an input end and an output end with a second sealing surface surrounding the output end of the input bore;
a third planar wafer sandwiched between the first and second wafers, the third planar wafer having a containment bore longitudinally disposed in and transverse to, a third plane of the third wafer, the containment bore having first and second openings at either end, each opening being surrounded by a third and fourth sealing surfaces;
a first porous membrane sealingly engaged between the first sealing surface of the first wafer and the third sealing surfaces of the third wafer so that a perimeter of the first porous membrane is sealed from fluid flow while a first fluid contact area of the first porous membrane is disposed between one opening of the containment bore and one of the output openings the first wafer; and
a second porous membrane sealingly engaged between the second sealing surface of the second wafer and the fourth sealing surfaces of the third wafer so that a perimeter of the second porous membrane is sealed from fluid flow while a second fluid contact area of the second porous membrane is disposed between the other opening of the containment bore and the input opening the second wafer, thereby enclosing a volume of the containment bore between the first and second porous membranes.

24. The device of claim 23 wherein at least one of the input and output conduit bores is configured with a conduit fitting assembly adapted to interconnect an external fluid conduit to at least one of the input and output conduit bores.

25. The device of claim 24 wherein the external fluid conduit is a capillary.

26. The device of claim 25 wherein a portion of the capillary extends into at least one of the input and output conduit bores.

27. The device of claim 24 wherein the external fluid conduit is a syringe needle.

28. The device of claim 24 wherein the external fluid conduit is a flexible tube.

29. The device of claim 24 wherein at least one conduit fitting assembly includes and at least one of the input and output bores include intermeshing threads for engaging the conduit fitting assembly with the input and output bores

30. The device of claim 23 wherein at least one of the input and output conduit bores is configured to taper from a wider first diameter at an external end of the conduit bore to a smaller second diameter of the conduit bore.

31. The device of claim 23 wherein at least one of the input and output conduit bores is configured to taper from a smaller first diameter of the conduit bore to a wider second diameter of the conduit bore that contacts the analyte absorbent material.

32. The device of claim 23 wherein the volume of the containment bore is 100 μl or less.

33. The device of claim 23 wherein the volume of the containment bore is 50 μl or less.

34. The device of claim 23 wherein the volume of the containment bore is 10 μl or less.

35. The device of claim 23 wherein the volume of the containment bore is 5 μl or less.

36. The device of claim 23 wherein the volume of the containment bore is 1 μl or less.

37. The device of claim 23 further including a plurality of third wafers stacked between the first and second wafers, each of the plurality of third wafers having separate containment bores, separate openings and separate sealing surfaces, and where at least one of the a third porous membranes is positioned between the containment bores of the stacked wafers and sealed around the separate opening between the separate sealing surfaces.

38. A system for analyzing microliter scale samples comprising,
an analytical instrument configured to receive and analyze a flow a fluid output from the device of claim 1.

39. The system of claim 38 further including a valve assembly in fluid communication with the device of claim 1 to alternatively direct a flow of fluid to or from the device of claim 1, to or from at least one of a sample reservoir, the analytical instrument and a waste outlet.

40. The system of claim 38 further including
a first valve assembly positioned between the first conduit bore and a sample reservoir, the first valve-like assembly being configured to alternatively direct a flow of sample to the first conduit assembly or to an external outlet; and
a second valve-assembly positioned between the second conduit bore and the analytical instrument, the second valve-like assembly being configured to alternatively direct a flow from the second conduit assembly to the analytical instrument or to an external outlet.

41. The system of claim 38 wherein the analytical instrument comprises a capillary electrophoresis device.

42. The system of claim 38 wherein the analytical instrument comprises a fluid chromatography device.

43. The system of claim 38 wherein the analytical instrument comprises a mass spectroscopy device.

44. The system of claim 38 further including a cell lysis chamber in fluid communication with at least one of the input and output ends of the device of claim 1 and operable to lyse a cell to release the cell's contents to form a sample prior to, or subsequent to, directing the sample through the device of claim 1.

45. The device of claim 1 wherein the volume of the containment bore is 500 μl or less.

46. The device of claim 1 where in the volume of the containment bore is 200 μl or less.

47. The device of claim 1 wherein a plurality of the central containment members are configured in a line to form a common central containment bore.

48. A kit comprising the device of claim 1 and including a plurality of the central containment members configured to be coupled in a line form a common central containment bore.

49. A system for analyzing microliter scale samples comprising, an analytical instrument configured to receive and analyze a flow a fluid output from the device of claim 23.

50. The system of claim 49 wherein the analytical instrument comprises a capillary electrophoresis device.

51. The system of claim 49 wherein the analytical instrument comprises a fluid chromatography device.

52. The system of claim 49 wherein the analytical instrument comprises a mass spectroscopy device.

53. The system of claim 49 further including a valve assembly in fluid communication with the device of claim 49 to alternatively direct a flow of fluid to or from the device of claim 49, to or from at least one of a sample reservoir, the analytical instrument and a waste outlet.

54. The system of claim 49 further including
a first valve assembly positioned between the first conduit bore and a sample reservoir, the first valve assembly being configured to alternatively direct a flow of sample to the first conduit assembly or to an external outlet; and
a second valve assembly positioned between the second conduit bore and the analytical instrument, the second valve assembly being configured to alternatively direct a flow from the second conduit assembly to the analytical instrument or to an external outlet.

55. The device of claim 1 further including first and second electrodes positioned to be in electrical contact through a conductive path across the central containment bore so that an electrical field can be applied across the central containment bore.

56. The device of claim 55 wherein the first and second electrodes extend laterally from the central containment member.

57. The device of claim 55 wherein the first and second electrodes can carry sufficient electrical power to lyse cells, organelles or viral particles that are bound in the central containment member.

58. The device of claim 21 wherein the heat conducting medium carries sufficient heat to lyse biological cells, organelles or viral particles while bound to the central containment member.

59. The device of claim 23 further including first and second electrodes extending from at least two of the first, second and third wafers and positioned to be in electrical contact through a conductive path across the central containment bore in the third wafer so that an electrical field can be applied across the central containment bore.

60. The device of claim 59 wherein the first and second electrodes extend laterally from a plane of at least two of the first, second and third wafers.

61. The device of claim 23 further including at least one heat conductive element positioned to be across, within or in close enough proximity to the central containment bore in the third wafer so that heat can be applied to the central containment bore.

62. The device of claim 37 further including a microfluidic channel that provides a path of fluid communication between an output opening from at least one of the separate containment bores to the input opening of another of the separate containment bores.

63. The device of claim 62 wherein at least one of the plurality of third wafers includes a plurality of containment bores adjacent to one another and wherein the microfluidic channel provides a fluid path from each output opening of the adjacent containment bores to a common input opening of a separate containment bore in another of the plurality of third wafers.

64. The device of claim 63 wherein the microfluidic channel contains a valve-like piston element that alternatively directs a flow of fluid from one of the adjacent containment bores to the common input opening of the separate containment bore.
